(19) United States
(12) Patent Application Publication
(10) Pub. No.: US 2019/0392327 A1
(43) Pub. Date: Dec. 26, 2019

(54) SYSTEM AND METHOD FOR CUSTOMIZING A USER MODEL OF A DEVICE USING OPTIMIZED QUESTIONING

(71) Applicant: Intuition Robotics, Ltd., Ramat-Gan (IL)

(72) Inventors: Shay ZWEIG, Harel (IL); Roy AMIR, Mikhmoret (IL); Itai MENDELSOHN, Tel Aviv-Yafo (IL); Assaf SINVANI, Modiin (IL); Dor SKULER, Oranit (IL)

(73) Assignee: Intuition Robotics, Ltd., Ramat-Gan (IL)

(21) Appl. No.: 16/450,128

(22) Filed: Jun. 24, 2019

Related U.S. Application Data
(60) Provisional application No. 62/689,192, filed on Jun. 24, 2018.

(51) Int. Cl. G06N 5/02; G06F 16/332

(52) U.S. Cl. CPC G06N 5/02; G06F 16/3329

(57) ABSTRACT

A system and method for customizing a user model of a device using optimized questioning. The method includes: retrieving a user model associated with a user of a device; identifying a plurality of data items having undetermined certainty levels with respect to the user model; selecting a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model; relaying the selected question to the user; receiving a user response to the question; and updating the user model based on the received user response.

### CROSS-REFERENCE TO RELATED APPLICATIONS

This application claims the benefit of U.S. Provisional Application No. 62/689,192 filed on Jun. 24, 2018, the contents of which are hereby incorporated by reference.

### TECHNICAL FIELD

The present disclosure relates generally to social robots, and, more specifically, to a method for customizing user models of social robots based on an active learning technique.

### BACKGROUND

Electronic devices, including personal electronic devices such as smartphones, tablet computers, consumer robots, and the like, have been recently designed with ever increasing capabilities. Such capabilities fall within a wide range, including, for example, automatically cleaning or vacuuming a floor, playing high definition video clips, identifying a user by a fingerprint detector, running applications with multiple uses, accessing the internet from various locations, and the like.

In recent years, microelectronics advancement, computer development, control theory development and the availability of electro-mechanical and hydro-mechanical servomechanisms, among others, have been key factors in a robotics evolution, giving rise to a new generation of automatons known as social robots. Social robots can conduct what appears to be emotional and cognitive activities, interacting and communicating with people in a simple and pleasant manner following a series of behaviors, patterns and social norms. Advancements in the field of robotics have included the development of biped robots with human appearances that facilitate interaction between the robots and humans by introducing anthropomorphic human traits in the robots. The robots often include a precise mechanical structure allowing for specific physical locomotion and handling skill.

Social robots are autonomous machines that interact with humans by following social behaviors and rules. The capabilities of these social robots have increased over the years and currently social robots are capable of identifying users' behavior patterns, learning users' preferences and reacting accordingly, generating electro-mechanical movements in response to user's touch or vocal commands, and so on.

These capabilities enable social robots to be useful in many cases and scenarios, such as interacting with patients that suffer from various issues including autism spectrum disorder, stress, assisting users to initiate a variety of computer applications, providing various forms of assistance to elderly users, and the like. Social robots usually use multiple input and output resources, such as microphones, speakers, display units, and the like, to interact with their users.

Social robots are most useful when they are configured to offer personalized interactions with each user. One obstacle of these social robots is determining various aspects of a user's personality and traits to not only engage with a user in a useful and meaningful manner, but to do so at appropriate times. For example, if a social robot is configured to ensure that an older user is kept mentally engaged, it is imperative to know what topics the user is interested in, when the user is most likely to respond to interactions from the social robot, what contacts should be suggested to communicate with, and so on.

Devices that learn their users' behavioral patterns and preferences are currently available, though the known learning processes employed are limited and fail to provide a deep knowledge about the user who is the target of an interaction with such a device. It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for customizing a user model of a device using optimized questioning. The method includes: retrieving a user model associated with a user of a device; identifying a plurality of data items having undetermined certainty levels with respect to the user model; selecting a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model; relaying the selected question to the user; receiving a user response to the question; and updating the user model based on the received user response.

Certain embodiments disclosed herein also include a non-transitory computer readable medium having stored thereon instructions for causing a processing circuitry to perform a process, the process including: retrieving a user model associated with a user of a device; identifying a plurality of data items having undetermined certainty levels with respect to the user model; selecting a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model; relaying the selected question to the user; receiving a user response to the question; and updating the user model based on the received user response.

Certain embodiments disclosed herein also include a system for customizing a user model of a device using optimized questioning, including: a processing circuitry; and a memory, the memory containing instructions that, when executed by the processing circuitry, configure the system to: retrieve a user model associated with a user of a device; identify a plurality of data items having undetermined certainty levels with respect to the user model; select a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model; relay the selected question to the user; receive a user response to the question; and update the user model based on the received user response.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a schematic diagram of a device for performing emotional gestures according to an embodiment.

FIG. 1B is a schematic diagram of a device for performing emotional gestures with a user device attached thereto, according to an embodiment.

FIG. 2 is a block diagram of a controller for controlling a device for customizing a user model using optimized questioning according to an embodiment.

FIG. 3 is a flowchart of a method for customizing a user model using optimized questioning according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for customizing a user model of an device, such as a social robot, based on an active learning technique employing optimized questions. The user model may be accessed and updated by the social robot.

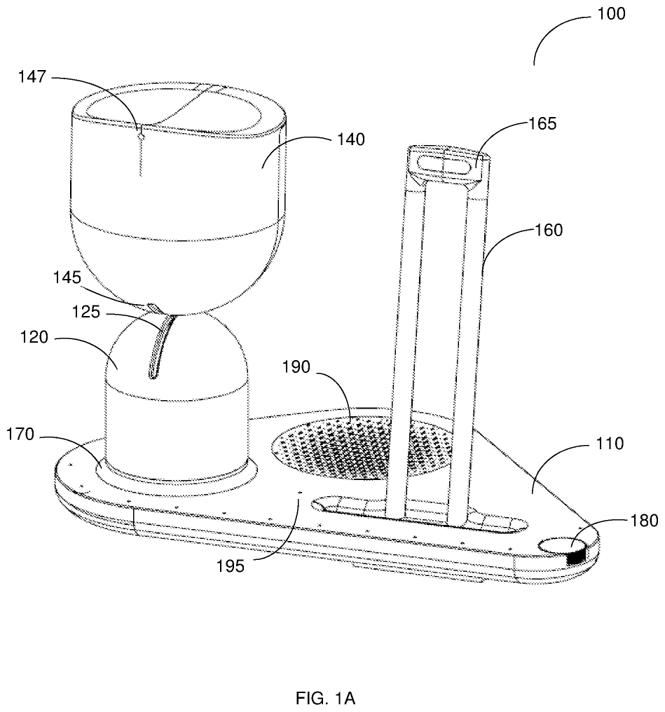

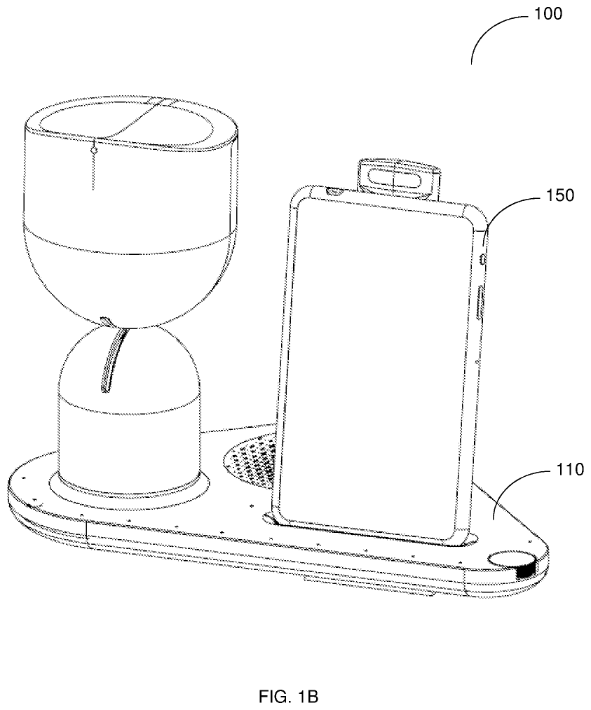

FIG. 1 is an example schematic diagram of a device 100 for performing emotional gestures according to an embodiment. The device 100 may be a social robot, a communication robot, and the like. The device 100 includes a base 110, which may include therein a variety of electronic components, hardware components, and the like. The base 110 may further include a volume control 180, a speaker 190, and a microphone 195.

A first body portion 120 is mounted to the base 110 within a ring 170 designed to accept the first body portion 120 therein. The first body portion 120 may include a hollow hemisphere mounted above a hollow cylinder, although other appropriate bodies and shapes may be used while having a base configured to fit into the ring 170. A first aperture 125 crossing through the apex of the hemisphere of the first body portion 120 provides access into and out of the hollow interior volume of the first body portion 120. The first body portion 120 is mounted to the base 110 within the confinement of the ring 170 such that it may rotate about its vertical axis symmetry, i.e., an axis extending perpendicular from the base. For example, the first body portion 120 rotates clockwise or counterclockwise relative to the base 110. The rotation of the first body portion 120 about the base 110 may be achieved by, for example, a motor (not shown) mounted to the base 110 or a motor (not shown) mounted within the hollow of the first body portion 120.

The device 100 further includes a second body portion 140. The second body portion 140 may additionally include a hollow hemisphere mounted onto a hollow cylindrical portion, although other appropriate bodies may be used. A second aperture 145 is located at the apex of the hemisphere of the second body portion 140. When assembled, the second aperture 145 is positioned to align with the first aperture 125.

The second body portion 140 is mounted to the first body portion 120 by an electro-mechanical member (not shown) placed within the hollow of the first body portion 120 and protruding into the hollow of the second body portion 140 through the first aperture 125 and the second aperture 145.

In an embodiment, the electro-mechanical member enables motion of the second body portion 140 with respect to the first body portion 120 in a motion that imitates at least an emotional gesture understandable to a human user. The combined motion of the second body portion 140 with respect to the first body portion 120 and the first body portion 120 with respect to the base 110 is configured to correspond to one or more of a plurality of predetermined emotional gestures capable of being presented by such movement. A head camera assembly 147 may be embedded within the second body portion 140. The head camera assembly 147 comprises at least one image capturing sensor that allows capturing images and videos.

The base 110 may be further equipped with a stand 160 that is designed to provide support to a user device, such as a portable computing device, e.g., a smartphone. The stand 160 may include two vertical support pillars that may include therein electronic elements. Example for such elements include wires, sensors, charging cables, wireless charging components, and the like and may be configured to communicatively connect the stand to the user device. In an embodiment, a camera assembly 165 is embedded within a top side of the stand 160. The camera assembly 165 includes at least one image capturing sensor (not shown).

According to some embodiments, shown in FIG. 1B, a user device 150 is shown supported by the stand 160. The user device 150 may include a portable electronic device such as a smartphone, a mobile phone, a tablet computer, a wearable device, and the like. The device 100 is configured to communicate with the user device 150 via a controller (not shown). The user device 150 may further include at least a display unit used to display content, e.g., multimedia. According to an embodiment, the user device 150 may also include sensors, e.g., a camera, a microphone, a light sensor, and the like. The input identified by the sensors of the user device 150 may be relayed to the controller of the device 100 to determine whether one or more electro-mechanical gestures are to be performed.

Returning to FIG. 1A, the device 100 may further include an audio system, including, e.g., a speaker 190. In one embodiment, the speaker 190 is embedded in the base 110. The audio system may be utilized to, for example, play music, make alert sounds, play voice messages, and cause other audio or audiovisual signals to be generated by the device 100. The microphone 195, being also part of the audio system, may be adapted to receive voice instructions from a user.

The device 100 may further include an illumination system (not shown). Such a system may be implemented using, for example, one or more light emitting diodes (LEDs). The illumination system may be configured to enable the device 100 to support emotional gestures and relay information to a user, e.g., by blinking or displaying a particular color. For example, an incoming message may be indicated on the device by a LED pulsing green light. The LEDs of the illumination system may be placed on the base 110, on the ring 170, or within on the first or second body portions 120, 140 of the device 100.

Emotional gestures understood by humans are, for example and without limitation, gestures such as: slowly tilting a head downward towards a chest in an expression interpreted as being sorry or ashamed; tilting the head to the left of right towards the shoulder as an expression of posing a question; nodding the head upwards and downwards vigorously as indicating enthusiastic agreement; shaking a head from side to side as indicating disagreement, and so on. A profile of a plurality of emotional gestures may be compiled and used by the device 100.

In an embodiment, the device 100 is configured to relay similar emotional gestures by movements of the first body portion 120 and the second body portion 140 relative to each other and to the base 110. The emotional gestures may be predefined movements that mimic or are similar to certain gestures of humans. Further, the device 100 may be configured to direct the gesture toward a particular individual within a room. For example, for an emotional gesture of expressing agreement towards a particular user who is moving from one side of a room to another, the first body portion 120 may perform movements that track the user, such as a rotation about a vertical axis relative to the base 110, while the second body portion 140 may move upwards and downwards relative to the first body portion 120 to mimic a nodding motion.

An example device 100 discussed herein that may be suitable for use according to at least some of the disclosed embodiments is described further in PCT Application Nos. PCT/US18/12922 and PCT/US18/12923, now pending and assigned to the common assignee.

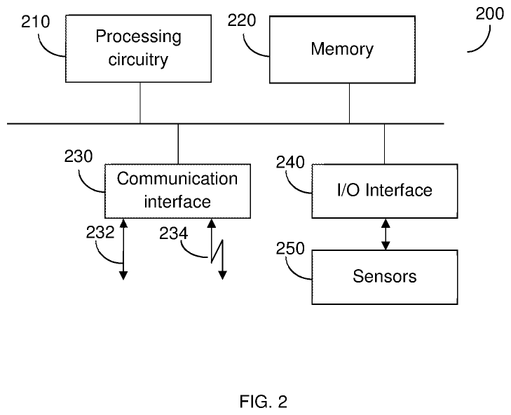

FIG. 2 is an example block diagram of a controller 200 of the device 100 implemented according to an embodiment. In an embodiment, the controller 200 is disposed within the base 110 of the device 100. In another embodiment, the controller 200 is placed within the hollow of the first body portion 120 or the second body portion 140 of the device 100. The controller 200 includes a processing circuitry 210 that is configured to control at least the motion of the various electro-mechanical segments of the device 100.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 200 further includes a memory 220. The memory 220 may contain therein instructions that, when executed by the processing circuitry 210, cause the controller 210 to execute actions, such as, performing a motion of one or more portions of the device 100, receive an input from one or more sensors, display a light pattern, and the like. According to an embodiment, the memory 220 may store therein user information, e.g., data associated with a user's behavior pattern.

The memory 220 is further configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing circuitry 210 to perform the various processes described herein. Specifically, the instructions, when executed, cause the processing circuitry 210 to cause the first body portion 120, the second body portion 140, and the electro-mechanical member of the device 100 to perform emotional gestures as described herein, including retrieving a user model, determining optimal questions to pose to a user to update data items within the user model, relay the question to the user, and update the user model based on a user response.

In an embodiment, the instructions cause the processing circuitry 210 to execute proactive behavior using the different segments of the device 100 such as initiating recommendations, providing alerts and reminders, and the like using the speaker, the microphone, the user device display, and so on. In a further embodiment, the memory 220 may further include a memory portion (not shown) including the instructions.

The controller 200 further includes a communication interface 230 which is configured to perform wired 232 communications, wireless 234 communications, or both, with external components, such as a wired or wireless network, wired or wireless computing devices, and so on. The communication interface 230 may be configured to communicate with the user device, e.g., a smartphone, to receive data and instructions therefrom.

The controller 200 may further include an input/output (I/O) interface 240 that may be utilized to control the various electronics of the device 100, such as sensors 250, including sensors on the device 100, sensors on the user device 150, the electro-mechanical member, and more. The sensors 250 may include, but are not limited to, environmental sensors, a camera, a microphone, a motion detector, a proximity sensor, a light sensor, a temperature sensor and a touch detector, one of more of which may be configured to sense and identify real-time data associated with a user.

For example, a motion detector may sense movement, and a proximity sensor may detect that the movement is within a predetermined distance to the device 100. As a result, instructions may be sent to light up the illumination system of the device 100 and raise the second body portion 140, mimicking a gesture indicating attention or interest. According to an embodiment, the real-time data may be saved and stored within the device 100, e.g., within the memory 220, and may be used as historical data to assist with identifying behavior patterns, changes occur in behavior patterns, updating a user model, and the like.

It should be noted that the robot 120 may be a stand-alone device, or may be implemented in, for example, a central processing unit of a vehicle, computer, industrial machine, smart printer, and so on, such that the resources of the above-mentioned example devices may be used by the controller 200 to execute the actions described herein. For example, the resources of a vehicle may include a vehicle audio system, electric seats, vehicle center console, display unit, and the like.

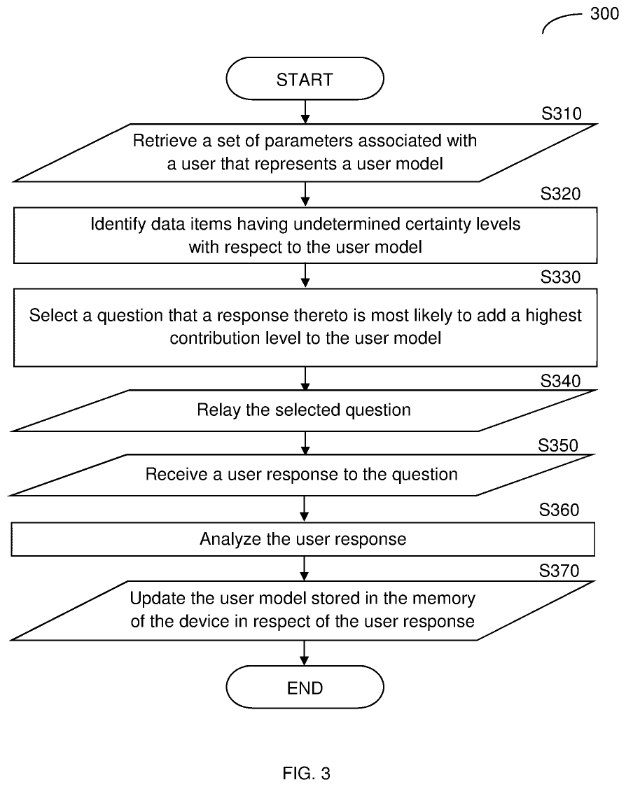

FIG. 3 is an example flowchart 300 of a method for customizing a user model using optimized questioning according to an embodiment. A user model is a collection of information associated with a user, i.e. a collection of data items that include a user's past and predicted behavior, preferences, historical data, and other similar information.

At S310, a set of parameters associated with a user is retrieved, e.g., using a sensor of the device 100, from a database, and the like. The set of parameters represents the user model associated with that user. In an embodiment, the parameters are retrieved using a sensor, such as the sensors 250 of the device 100 as further described above in FIGS. 1A, 1B and 2. In a further embodiment, at least part of the retrieved parameters have been previously collected and stored in a database where they are retrieved therefrom, e.g., a cloud database accessible via the Internet. The user is a person who is the target of interaction with such a device, such as a predefined default user of the device. The collected set of parameters may be additionally collected from a user calendar, social media websites, a user's email account, and the like. Access to these accounts may be granted directly by the user. The set of parameters may be indicative of various demographic data associated with the user, such as their geographic location, age, gender, mother tongue, and the like.

At S320, a plurality of data items having undetermined certainty levels with respect to the user model are identified. The plurality of data items is a collection of information that may be directly or indirectly associated with a physical interaction to be performed by a device for performing emotional gestures with respect to a user model. Data items that are directly related to, for example, a physical interaction of playing music may be indicative of the kind of music the user likes to listen to, a preferred artist of the user, the time of day the user prefers to listen to music, the duration of a listening session, and the like. Data items that are indirectly related to, for example, a physical interaction of playing music may be indicative of the time of day when the user is more active, the typical duration the user is focused on the music, and so on.

The certainty level of these data items is a value associated with each item and it is indicative of the amount of information currently available with respect to a specific data item. Various data items may include various values, or undetermined values, associated with a particular user model. For example, a device associated with a user model may contain a data item related to a user's preferred lecture topics above a predetermined certainty level; however, several associated data items, such as a preferred lecture duration, a preferred lecturer, and the user's preferred time at the day to listen to such a lecture may each have undetermined certainty levels.

At S330, a question is selected, e.g., from a plurality of predetermined questions, where a response to the question is determined to most likely add a highest contribution level to the user model. The highest contribution level to the user model may allow for, e.g., the greatest number of data items to be determined above the certainty level; one or more data items, i.e., not the greatest number, that currently provide the highest contribution level to the user model; the contribution of the response to the question to each data item; the importance of the data item associated with the question, and the like. The highest contribution level to the user model may be determined based on an analysis of a first contribution level of the question to at least one data item of the plurality of data items and a second contribution level of the at least one data item to the user model.

The first contribution level may indicate the influence level of the question on the at least one data item. In an embodiment, the influence level of a question may be predetermined. Namely, different weight values can be assigned to various questions associated with at least one data item. The first contribution level may allow determining whether the at least one data item will be determined above the certainty level by receiving a response to the selected question. For example, an answer to a first question “what are your hobbies?” can allow for the determination, above the certainty level, of several data items that have not yet been determined above a predetermined certainty level. Conversely, an answer to a second question “do you like sports?” may only provide a determination of the certainty level of a single data item in the user model. It should be noted that the contribution level of each question may differ for each data item.

The second contribution level may indicate the influence level of having the data related to the at least one data item on the overall user model. For example, a first data item may indicate that “the user prefers to be active during morning hours,” while a second data item indicates that “the user likes dogs.” It may be determined that the first data item provides more useful information regarding the user than the second data item. That is to say, knowing that the user prefers to be active during morning hours may allow an associated device to suggest the user to go out for a walk, meet friends and family, do yoga, etc., during morning hours, while knowing that the user likes dogs may be less valuable to the overall user model. In an embodiment, the result of the analysis of the first and the second contribution levels may be to select a question, e.g., from a plurality of predetermined questions, that a response thereto contributes with a certain degree to a single data item, as opposed to multiple data items, where the single item is determined to have a significant contribution to the user model.

According to one embodiment, each of the plurality of questions may be associated with one or more data items of the plurality data items within the user model. Each data item of the plurality of data items may be associated with a contribution level to the user model. The plurality of questions may be stored in a database or in a local memory of the device, e.g., the memory 220 of FIG. 2. It should be noted that the user may be interrupted when the device 100 poses these questions proactively, and therefore it may be desirable to be most efficient by configuring the device to select the minimum amount of questions required for contributing the most to the user model.

At S340, the selected question is relayed to a user, e.g., by the device 100. The question may be relayed using a speaker of the device, using a display unit of a user device, such as the user device 150 that is adapted to communicate with the device 100, and the like. According to an embodiment, the selected question is relayed by the device 100 upon determination of an ideal time for user engagement. For example, the determination such a time may be made based on past interactions with the device 100 by the user, where the user has responded most positively in comparison to other times.

At S350, a user response to the question is received. The user response may be received by collecting sensory information from a sensor, such as the sensors 250 of the device 100, from the user. The response may include verbal content, gestures made by the user, input given by a user, a combination thereof, and so on.

At S360, the user response is analyzed to determine the response. The analysis may be achieved using speech recognition techniques, computer vision techniques, and the like.

At S370, based on the user response, the user model is updated. Upon performing the method described herein above, the user model may add one or more data items to the user model or add certainty levels to one or more of the plurality of data items based on the user responses to the selected question that contribute the most to the enrichment of the user model. The updated user model can be used to allow the device 100 to adjust the execution of at least a physical interaction with the user.

The at least a physical interaction may include performing a motion by one or more portions of the device 100, e.g., display a light pattern, show a video, emit sound, use a voice, and the like. The at least a physical interaction may be related to various user activities, including a physical activity, reading, listening to music, listening to a lecture, communicating with a friend, meeting a friend or a family member, and so on. For example, before asking a user about their hobbies, the device 100 may not have any way of knowing what the user's hobbies are. After asking such a question selected according to the disclosed method, the device 100 enriches its knowledge of the user's hobbies such that when the device 100 executes an interaction with the user, an updated user model that includes new data items regarding the user's hobbies can be used to allow the device 100 to adjust the execution accordingly.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for customizing a user model of a device using optimized questioning, comprising:
retrieving a user model associated with a user of a device;
identifying a plurality of data items having undetermined certainty levels with respect to the user model;
selecting a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model;
relaying the selected question to the user;
receiving a user response to the question; and
updating the user model based on the received user response.

2. The method of claim 1, wherein updating the user model includes at least one of: adding at least one data item to the user model and adding at least a certainty level to the plurality of data items having undetermined certainty levels.

3. The method of claim 1, wherein an execution of at least a physical interaction with the user is adjusted based on the updated user model.

4. The method of claim 1, further comprising:
determining an ideal time for user engagement; and
relaying the selected question is at the determined ideal time.

5. The method of claim 1, wherein each data item of the plurality of data items is associated with a contribution level to the user model.

6. The method of claim 5, wherein the selected question is determined to most likely add a highest contribution level to at least one of the plurality of data items.

7. The method of claim 1, wherein the first contribution level allows for determining whether the at least one data item will be determined above the certainty level by receiving a response to the selected question.

8. The method of claim 1, wherein the second contribution level indicates an influence level of having data related to the at least one data item on the overall user model.

9. The method of claim 1, wherein the user model is represented by a set of parameters associated with the user.

10. A non-transitory computer readable medium having stored thereon instructions for causing a processing circuitry to perform a process, the process comprising:
retrieving a user model associated with a user of a device;
identifying a plurality of data items having undetermined certainty levels with respect to the user model;
selecting a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model;
relaying the selected question to the user;
receiving a user response to the question; and
updating the user model based on the received user response.

11. A system for customizing a user model of a device using optimized questioning, comprising:
a processing circuitry; and
a memory, the memory containing instructions that, when executed by the processing circuitry, configure the system to:
retrieve a user model associated with a user of a device;
identify a plurality of data items having undetermined certainty levels with respect to the user model;
select a question that a response thereto is most likely to allow a highest contribution level to the user model, wherein the highest contribution level to the user model is determined based on an analysis of a first contribution level of the question to at least one data item of the plurality of data items and a second contribution level of the at least one data item to the user model;
relay the selected question to the user;
receive a user response to the question; and
update the user model based on the received user response.

12. The system of claim 11, wherein updating the user model includes at least one of: adding at least one data item to the user model and adding at least a certainty level to the plurality of data items having undetermined certainty levels.

13. The system of claim 11, wherein an execution of at least a physical interaction with the user is adjusted based on the updated user model.

14. The system of claim 11, wherein the system if further configured to:
determine an ideal time for user engagement; and
relay the selected question is at the determined ideal time.

15. The system of claim 11, wherein each data item of the plurality of data items is associated with a contribution level to the user model.

16. The system of claim 15, wherein the selected question is determined to most likely add a highest contribution level to at least one of the plurality of data items.

17. The system of claim 11, wherein the first contribution level allows for determining whether the at least one data item will be determined above the certainty level by receiving a response to the selected question.

18. The system of claim 11, wherein the second contribution level indicates an influence level of having data related to the at least one data item on the overall user model.

19. The system of claim 11, wherein the user model is represented by a set of parameters associated with the user.
